(19) United States
(12) Patent Application Publication
(10) Pub. No.: US 2002/0126728 A1
(43) Pub. Date: Sep. 12, 2002

(54) Extruded electrode for submerged-arc electric furnace

(75) Inventor: Pio Paolo Benvegnu, Belluno (IT)

Correspondence Address: ROTHWELL, FIGG, ERNST & MANBECK, P.C., 1425 K STREET, N.W., SUITE 800, WASHINGTON, DC, 20005, US

(73) Assignee: Industria Elettrica "INDEL" S.p.A., Italy

(21) Appl. No.: 09/908,833

(22) Filed: Jul. 20, 2001

(30) Foreign Application Priority Data
Jul. 24, 2000 (IT) MI2000A001685

(51) Int. Cl. H05B 7/09

(52) U.S. Cl. 373/89

(57) ABSTRACT

A self-baking extruded electrode for a submerged arc electric furnace includes [comprising: -] a metal outer casing (1), cylindrical in shape, on which electric contact plates (5) are applied for the electrical supply. The electrode includes [-] an inner part [comprising] with electrolytic paste (3, 7, 8) anchored to an anchoring core (2) disposed axially inside the casing (1)[, -] an extrusion device (10) is connected to [said] the anchoring core (2) to control axial sliding of [said] the inner part of the electrode with respect to [said] the casing (1)[, downward]. Downward axial sliding of the inner part of the electrode with respect to the casing (1) [taking] takes place by the action of the force of gravity, [through the aid of] with regulation and control [means for] of the baking of the electrolytic paste (8) [whilst] while the casing (1) is kept fixed by [means of clamping means] clamps (14, 15).

The present invention refers to an extruded electrode for a submerged-arc electric furnace.

At present virtually all reduction processes for metal oxides and their alloys, where the reactions involved are strongly endothermic, are carried out with machines called resistance arc or submerged-arc furnaces.

The submerged-arc electric furnace is a machine able to transform electric energy into high-temperature thermal energy. Said electric furnace consists of the following basic parts:

a) the crucible or stack which is a cylindrical container that forms the core of the reactor into which the materials to be reduced and the electric energy are introduced. During the process the crucible normally makes a rotary movement.

b) the electrodes which are the end part of the electrical supply circuit and serve to convey the electric energy into the area of the reactor in which the arc is generated.

Electric submerged-arc furnaces are generally three-phase and are provided with three electrodes situated at the vertices of an equilateral triangle inscribed within the circumference of the refractory lining of the crucible.

Of particular importance at present among the reduction processes for metal oxides and their alloys is the production of metal silicon. The production of metal silicon is essentially a reduction of silicon dioxide with carbon. This oxide reduction takes place at an arc temperature (T≧1820° C.) according to the basic reaction:

SiO₂ (quartz)+2C=Si (liquid)+2CO (gas)

Silicon dioxide is first introduced into the furnace as natural quartzite pieces. Carbon is obtained by means of charge carbons of various types and by means of the electrodes. These materials are appropriately selected to avoid introducing impurities into the product.

The electric energy is brought into the arc area by means of the electrodes. The electric arc that sparks between the electrodes and the bottom of the crucible (hearth or star centre) converts the electric energy into high-temperature thermal energy.

In the production of metal silicon the process that takes place at each electrode can be represented in a schematic, simplified form as in FIG. 1.

Inside the reactor in the arc area where the reduction is under way, the electrodes are constantly eroded through a dynamic effect and a chemical effect and must be replenished. This replenishment is carried out at the top of the electrodes with the furnace in operation.

Consequently all the elements that make up the eroded part of the electrode enter into the reduction process and, if they are contaminants, are found in the finished product in the form of impurities.

The main metal impurities that contaminate metal silicon are iron, calcium and aluminium. All the raw materials, including the electrode, that make up the components of the reaction, some to a greater and some to a lesser extent, contribute numerous metal oxides, mainly: Fe₂O₃ (iron oxide), A1₂O₃ (aluminium oxide), and CaO (calcium oxide).

On this basis it is essential, compatibly with the availability and price, to use mixtures of the purest raw materials possible. This condition is difficult to fulfil and at times economically prohibitive. Consequently, an additional process has been developed downstream of tapping, called refining, which allows these impurity elements to be reduced within acceptable limits.

For iron, this refining process is not chemically possible, so the only method of limiting the presence of impurities in the finished product is to reduce the amount of impurities in the materials that take part in the reduction.

Having said this, it is known that a traditional self-baking electrode, known as a Soderberg electrode, is used for the production of iron alloys, such as iron-silicon up to 90-95%.

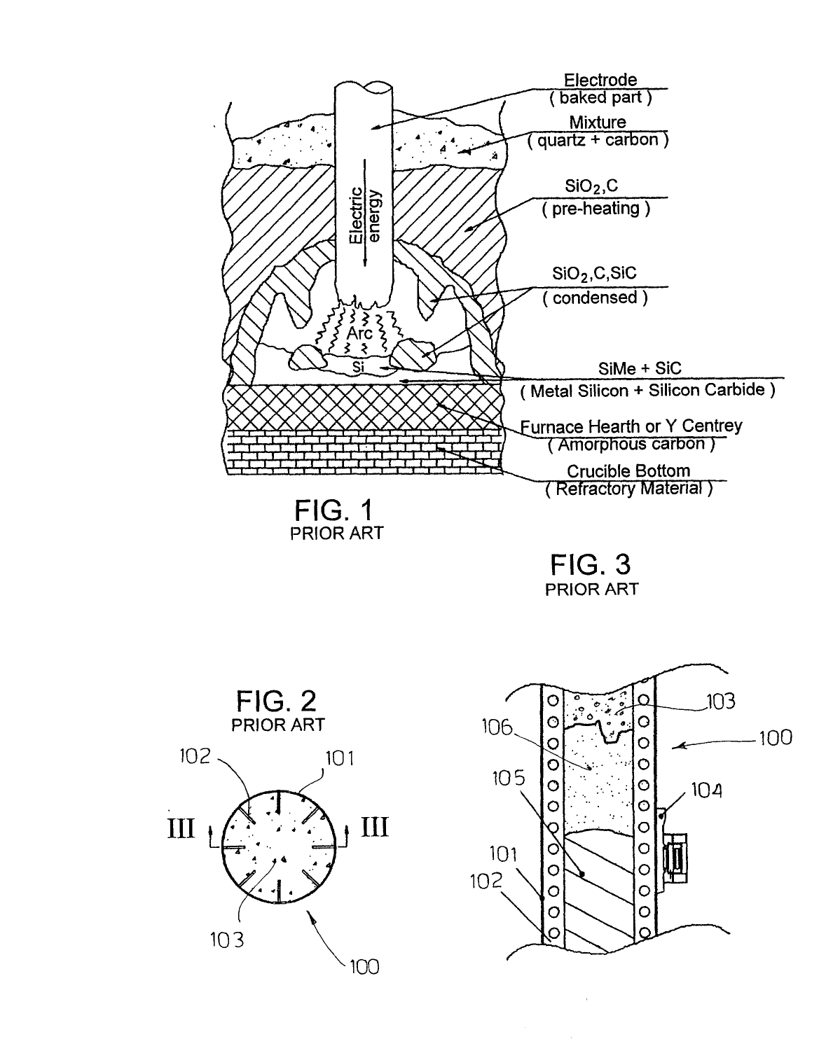

As shown in FIGS. 2 and 3, the self-baking Soderberg electrode, designated as a whole with reference numeral 100, comprises a cylindrical shell (casing) 101 of sheet iron or stainless steel with a thickness of 1.2-2 mm, provided on the inside with radial fins 102 longitudinally electro welded to the casing 101.

The inside of the casing 101 is filled with electrolytic paste 103 which is a mixture of various carbons, generally calcined and with a low ash content, in evenly distributed granular sizes from 0 to 15 mm, mixed with tar pitch which acts as a binder. This mixture is solid at ambient temperature and is prepared in blocks or briquettes which are charged, to replenish the consumed electrode, on the top of the electrode column.

A current-carrying plate 104 able to convey the electric current to the electrode to spark the arc is provided on the outer surface of the casing 101. The current-carrying plate 104 is generally positioned above the level of the material to be reduced in the crucible.

Inside the casing 101, self-baking of the paste 103 takes place exploiting the heat derived from the furnace by convection, radiation and a Joule effect. The paste 103 becomes fluid at about 60-160 ° C. and towards 600 ° C. the tar binder distils leaving cracked residues able to cement together the various carbons of the paste.

As shown in FIG. 3, in a submerged-arc electric furnace the typical situation for self-baking of the electrode 100 is as follows:

a) baked electrode 105 from the bottom tip up to about half the height of the current carrying plates 104;

b) pasty and liquid electrode paste 106, from the same area of the plates 104 to 2-3 metres above the level of the plates;

c) top area 103 formed by 3-4 meters of solid electrode paste in blocks.

The electrode mass 100 (comprising the baked electrode 105, the fluid electrode paste 106 and the solid electrode paste 103) is firmly anchored to the casing 101 by means of the tongues 102. Thus, the core of the electrode is integral with the casing and as its bottom tip is consumed, the entire electrode must be lowered to maintain optimal arc conditions.

Because of this, the self-baking Soderberg electrode cannot be used in the production of metal silicon with a low iron content because its metal casing 101 would introduce high percentages of iron impurities into the end product. In fact with a carbon steel casing a percentage of about 1% of iron is introduced; with a stainless steel casing a percentage of about 0.75% of iron is introduced.

Consequently, to product metal silicon with a low iron content, according to the prior art another type of electrode known as a pre-baked electrode is used. The pre-baked electrode comprises a cylinder of amorphous carbon which is pre-baked, machined on a lathe and provided in various sizes according to the power of furnaces for which it is intended. The pre-baked amorphous carbon introduces a low percentage of iron during the reduction process.

Said pre-baked electrode has the drawback that the pre-baked amorphous carbon cylinders are extremely expensive and thus the pre-baked electrode represents about 15-20% of the cost of the finished product.

This drawback is overcome in part by Italian patent 1.255.937 which describes an electrode, called an extruded electrode since the inner part of the electrode can slide with respect to the casing. Said electrode comprises a graphite core anchored to electrode paste disposed inside a casing. The part of the electrode paste that emerges from the bottom of the casing is baked inside the arc furnace, during the production process, giving rise to the formation of the self-baking electrode.

Keeping the casing fixed, as the electrode is consumed, the electrode paste and the graphite core are forcibly pushed downward by means of a linear actuator. In this manner the casing, containing iron impurities, is not melted during the process and thus no percentages of iron impurities are introduced into the finished product.

Although such an electrode uses electrode paste, which is cheaper than amorphous carbon, it presents various drawbacks.

In fact the forced downward thrust of the electrode column consisting of the electrode paste and the graphite core generates high bending and compressive stresses. Since the electrode column is long and rigid, the bending and compressive stresses often cause fractures or failure thereof, resulting in the need to replace the electrode.

Furthermore, the particular supporting structure of the electrode provides clamps or other gripping means to block the inner electrode column and the graphite core. Consequently when the type of electrode in use has to be changed, it is necessary to change these clamps with consequent halts in the production process.

The aim of the present invention is to eliminate the drawbacks of the prior art, providing an extruded electrode for electric arc furnaces that is economical and easy to make.

Another object of the present invention is to provide such an extruded electrode that is versatile and able to avoid breaks in the production cycle.

Yet another object of the present invention is to provide such an extruded electrode that is safe and able to avoid possible breakages or fractures.

These objects are achieved in accordance with the characteristics listed in appended independent claim 1.

Advantageous embodiments of the invention are apparent from the dependent claims.

The extruded electrode according to the invention comprises a substantially cylindrical outer metal casing filled with electrode paste anchored to an anchoring core disposed axially inside the casing. The anchoring core integral with the electrode paste, thanks to the action of gravity, can slide downward inside the casing. The anchoring core is supported by an extrusion device that regulates downward sliding thereof, so that a bottom part of the electrode paste is baked inside the arc furnace, forming the self-baked electrode part.

The fact that the inner part of the electrode, consisting of the anchoring core integral with the electrode paste, can slide by gravity inside the casing avoids possible breakage or fractures of the core due to bending and compressive stresses exerted on the head of the core to favour lowering thereof.

This sliding of the inner part of the electrode is allowed by a suitable regulation and control of the self-baking process of the electrode.

Furthermore, the electrode according to the invention also has locking and driving means applied to the casing to allow locking and vertical sliding of the casing, even during operation of the furnace.

Furthermore, the electrode according to the invention also has locking means applied to the core to ensure safety locking of the core.

Further characteristics of the invention will be made clearer by the detailed description that follows, referring to purely exemplary and therefore non-limiting embodiments thereof, illustrated in the appended drawings, in which:

FIG. 1 is a schematic view illustrating the metal silicon production process in a submerged-arc furnace;

FIG. 2 is a cross sectional view of a self-baking electrode of the Soderberg type;

FIG. 3 is an axial sectional view along the plane of section III-III of FIG. 2;

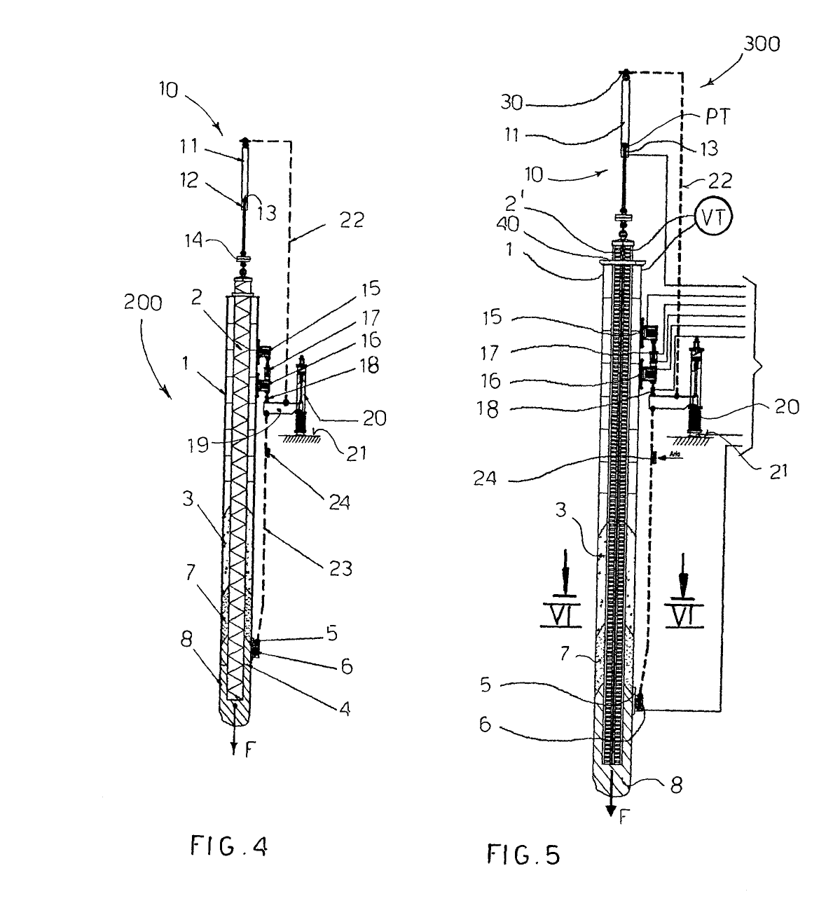

FIG. 4 is an axial sectional schematic view illustrating an electrode according to the invention;

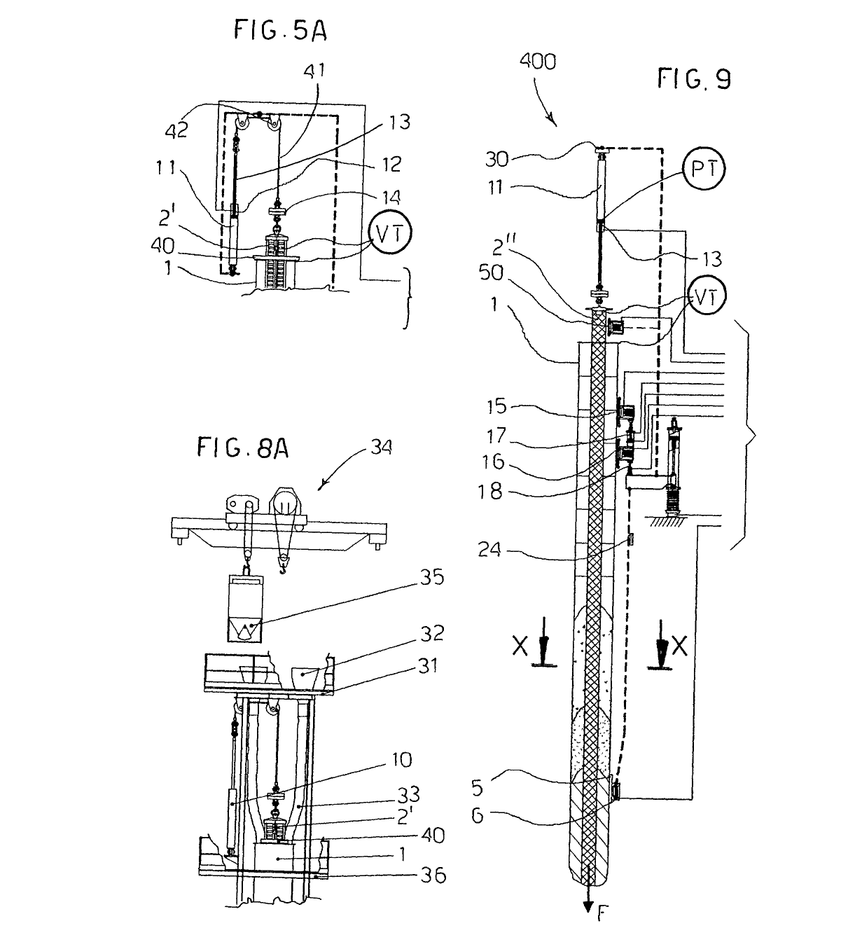

FIG. 5 is an axial sectional view illustrating a first embodiment of the electrode according to the invention;

FIG. 5A shows a variant applied to the electrode of FIG. 5;

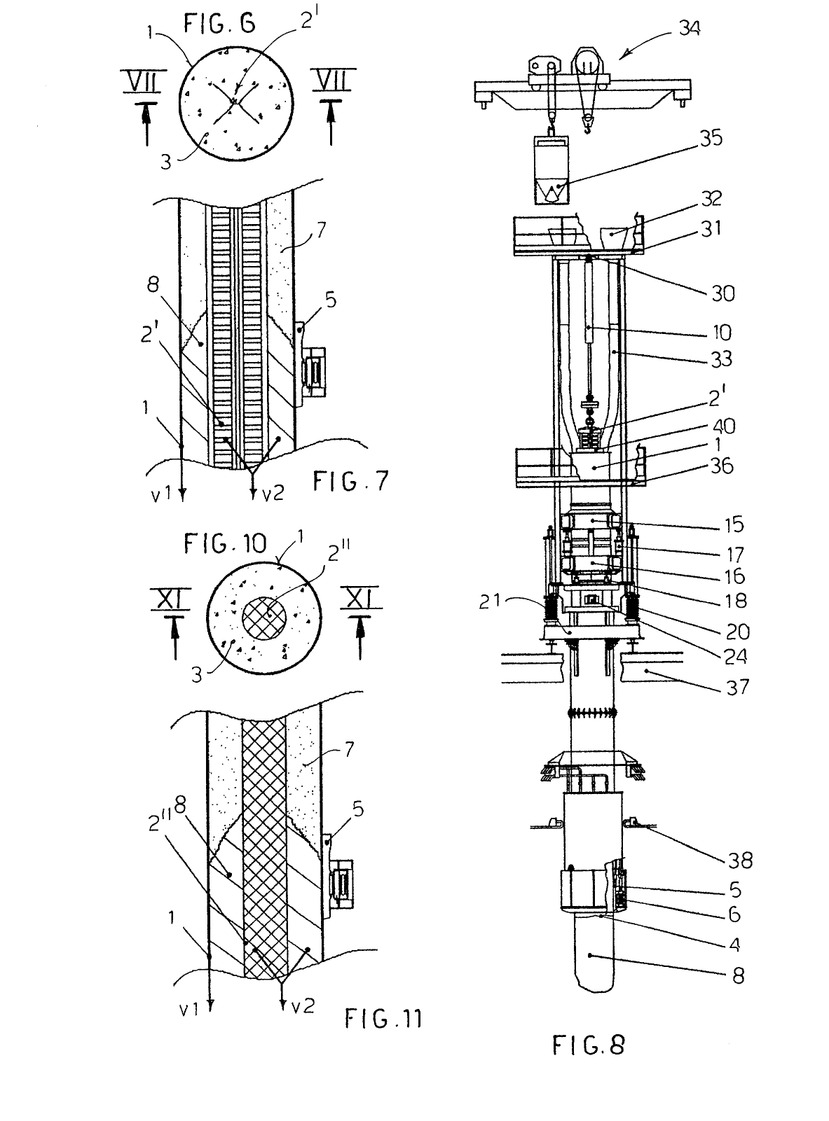

FIG. 6 is a cross sectional view along the line of section VI-VI of FIG. 5;

FIG. 7 is a longitudinal sectional view along the line of section VII-VII of FIG. 6;

FIG. 8 is an overall side elevational view, with some elements broken off, illustrating the supporting structure of the electrode according to the first embodiment of the invention;

FIG. 8A illustrates a variant of the extrusion device of FIG. 8;

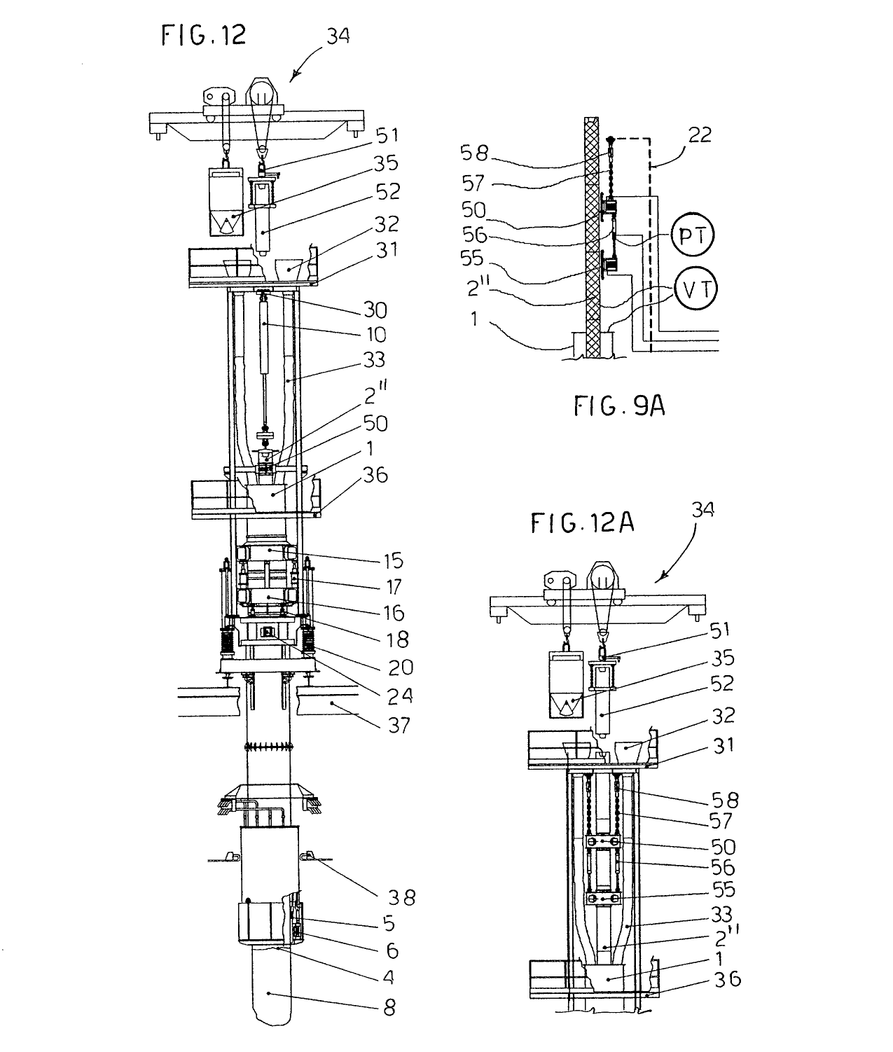

FIG. 9 is a sectional side view illustrating a second embodiment of the electrode according to the invention;

FIG. 9A is a view like FIG. 9, illustrating a variant of the second embodiment;

FIG. 10 is a sectional view taken along the plane of section X-X of FIG. 9;

FIG. 11 is a sectional view taken along the plane of section XI-XI of FIG. 10;

FIG. 12 is a side elevational overall view, with some elements broken off, illustrating the supporting structure of the electrode according to the second embodiment;

FIG. 12A is a view like FIG. 12, illustrating a variant of the second embodiment

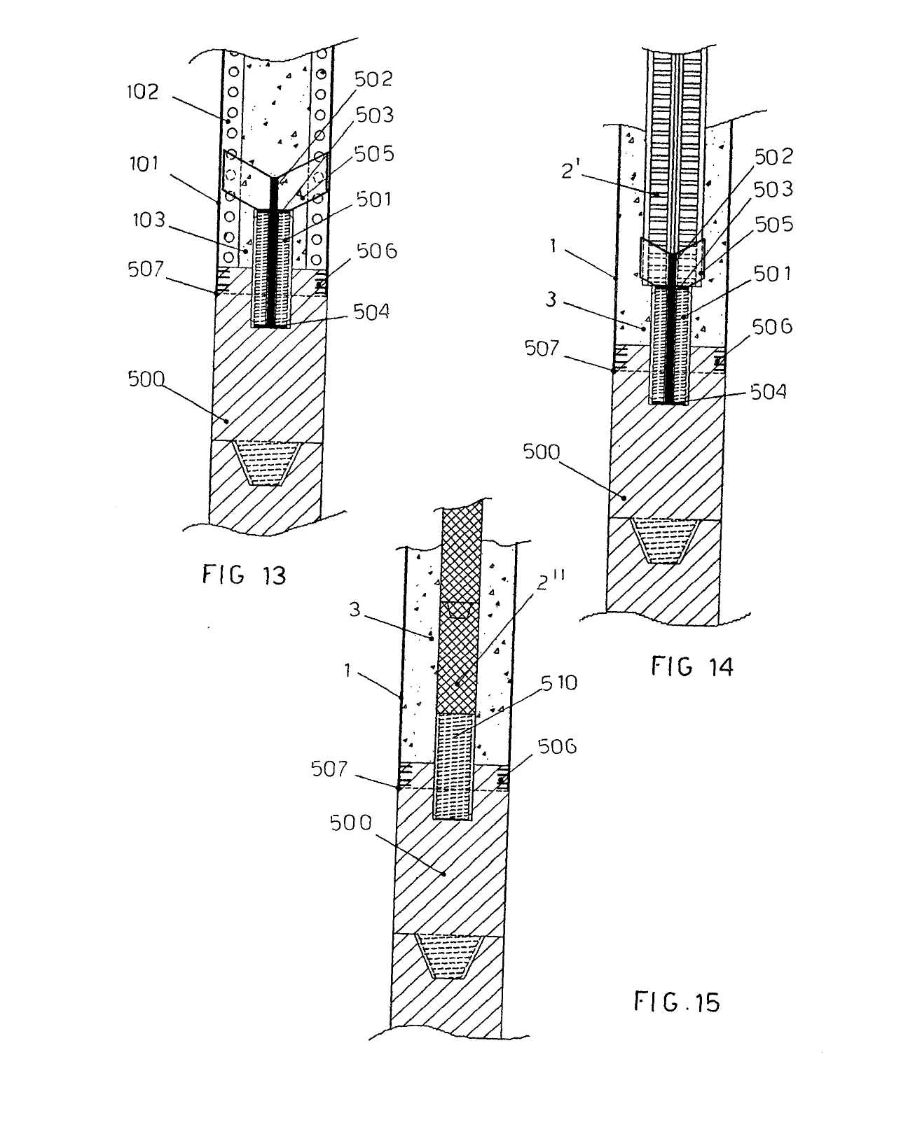

FIGS. 13-15 are axial sectional views showing respectively the passage from a pre-baked electrode to a Söderberg electrode, to an extruded electrode with a metal core and to an extruded electrode with a graphite core;

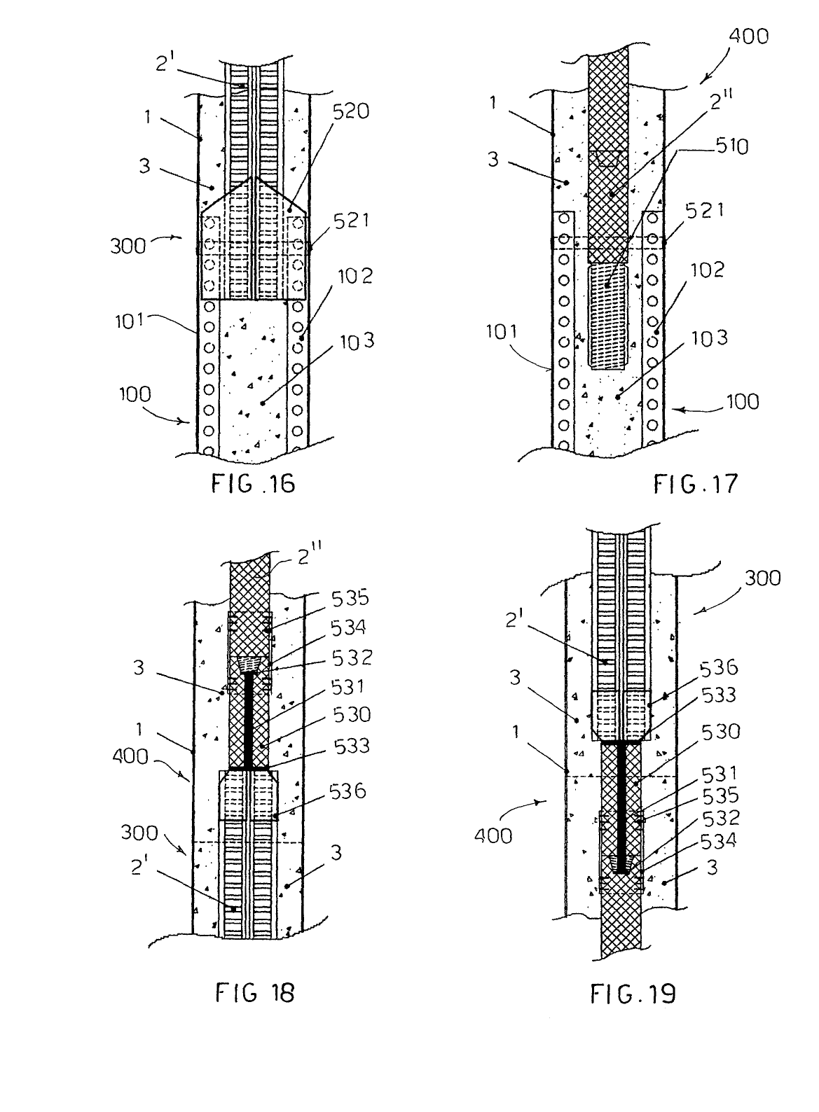

FIGS. 16 and 17 are axial sectional views showing respectively the passage from a Söderberg electrode to an extruded electrode with a metal core and to an extruded electrode with a graphite core;

FIGS. 18 and 19 are axial sectional views schematically illustrating the passage from an extruded electrode with a metal core to an extruded electrode with a graphite core and vice versa.

FIG. 4 schematically illustrates an electrode according to the invention designated as a whole with reference numeral 200. The electrode 200 comprises an outer casing 1, formed by means of a plurality of cylinders of metal material, stacked one on top of the other.

Disposed axially within the casing 1 is a core 2 which forms the anchoring structure of the electrode. Again disposed within the casing 1 is a solid electrode paste 3 in the form of briquettes which are placed around the core 2.

Near the bottom end 4 of the casing 1 electrical contact plates 5 supported by a thrust ring 6 are provided. The plates 5 are adjusted in position so as to be situated above the level of the mixtures inside the electric arc furnace.

In this manner, near the plates 5, the solid electrode paste 3 is converted into fluid electrode paste 7 by heating. Below the plates 5 the fluid electrode paste 7 is baked, forming the baked electrode 8 which is situated below the bottom end 4 of the casing 1 and is anchored to the core 2. The bottom end of the baked electrode 8 must be situated at a suitable distance from the hearth of the arc furnace for the electric arc to spark.

The inner part of the electrode 200 will be subject to a force F directed vertically downward, equal to the weight of the baked electrode 8, the liquid electrode paste 7, the solid electrode paste 3 and the core 2. Thus the inner part of the electrode, though the action of gravity, tends to slide downward with respect to the casing 1 which can be kept fixed.

The core 2 is supported by an extrusion device 10. The extrusion device 10 comprises a cylinder 11 with a chamber 12 within which a piston 13 can slide. The chamber 12 is filled with oil under pressure. The end of the piston 13 outside the chamber 12 is connected to a hook 14 fixed to the upper end of the core 2, so as to retain the inner part of the electrode which is anchored to the core 2.

Applied to the outer surface of the casing 1 are an upper clamp 15 and a lower clamp 16 between which a sliding cylinder or jack 17 is interposed to regulate vertical movement of the casing 1 in a conventional manner. An additional sliding cylinder 18 is provided under the lower clamp 16.

The additional jack 18 is supported by a support 19 connected to the regulating cylinder 20 of the electrode disposed on a horizontal surface 21. The support 19 is connected by means of a first rigid mechanical connection 22 to the extrusion device 10 and by means of a second rigid mechanical connection 23 to the contact plates 5. In this manner, by means of the regulating cylinder 20, the vertical movements of the extrusion device 10, of the contact plates 5 and of the clamps 15 and 16 of the casing 1 can be controlled.

On the second rigid mechanical connection 23 a barrier air supply or inlet 24 is provided to inject air into the gap between the casing 1 and the inner part of the electrode, in order to thermo regulate baking of the electrode.

With reference to FIGS. 5-8 a first embodiment of the invention is described in which the elements already described are designated with the same reference numerals.

FIG. 5 shows an electrode 300 substantially similar to the electrode 200 previously described. Schematically illustrated in the electrode 300 is the oleodynamic system of the machine by which oil is supplied, by means of respective conduits, to the chamber 13 of the extrusion device 10, the clamps 15 and 16, the jacks 17 and 18, the regulating cylinder 20 and the plate thrust ring 6.

Furthermore, the rigid mechanical connection 22 is connected to the end of the extrusion device 10, by means of a floating system 30 able to allow floating of the extrusion device 11 to lighten the axial loads to which the core 2′ is subjected during its vertical downward movement, in order to avoid possible breakages and fractures.

Furthermore, at the top end of the casing 1 a safety cross piece 40 is provided which serves for safety locking of the metal core 2′.

Furthermore a measuring apparatus called a baking meter (VT) to measure the voltage difference between the casing 1 and the core 2′ is provided.

In the oil chamber 13 of the extrusion device 10 a pressure gauge is provided to measure the oil pressure in said chamber 13.

In this first embodiment of the invention, the core 2′ is made from a metal structure which is cross-shaped in cross section (FIG. 6). The core 2′ is anchored to the baked electrode 8, thus the liquid electrode paste 7 and the solid electrode paste 3 also are integral with the core 2 and free from the casing 1. In this manner the downward movement of the casing 2 and of the inner part of the electrode (core and electrode paste) can be regulated independently.

With reference to FIG. 7, if the sliding speed of the casing 1 with respect to the contact plates 5 is indicated with vl and the speed of sliding of the inner part of the electrode with respect to the contact plates 5 with v2, there is a sliding relationship between the casing 1 and the inner part of the electrode given by R=v1/v2, in which 1≦R≦1/20.

For R=1 a total sliding of the casing and of the inner part occurs at the same speed. For R=1/20 sliding of the inner part of the electrode, that is to say extrusion, occurs.

FIG. 8 shows an overall view of the supporting structure of the electrode 300. An upper horizontal service surface 31 that supports the extrusion device 10 is provided. Positioned on the upper service surface 31 are two hoppers 32 for charging of the electrode paste, connected to respective flexible tubes 33, which lead into the casing 1.

Above the upper surface 31 a loading device 34 is provided to convey a bucket 35 containing the electrode paste onto the hoppers 32.

Near the top end of the casing 1 there is a second service surface 36 which serves for assembly of the cylinders of the casing which are piled in the upper end of the casing 1 during the production cycle.

Beneath the supporting surface 21 of the adjustment cylinders 20 a surface 37 supporting the supporting columns of the electrode is provided.

Slightly above the plates 5 a hood 38 is provided to trap the furnace fumes.

In this first embodiment of the invention the cylinder 11 and the piston 13 of the extrusion device 10 are disposed above the top end of the casing 1 and coaxial with the axis of the core 2′. In the event of there not being sufficient space between the upper service surface 31 and the second service surface 36 to house the extrusion device 10, a variant can be envisaged.

As shown in FIGS. 5A and 8A, the extrusion device 10 is mounted sideward with respect to the axis of the electrode. In this case the end of the piston 13 outside the cylinder 11 is hooked to a cable 41 which is driven by means of pulleys 42 to couple with the hook 14 of the top end of the core 2′.

With reference to FIGS. 9-12 a second embodiment of an electrode 400 according to the invention is described, in which like elements to those previously described are designated with like reference numerals.

The electrode 400 comprises a graphite core 2″ having a cylindrical shape (FIG. 10). As shown in the Figures, the electrode 400 has all the elements provided in the electrode 300 according to the first embodiment, and in addition the electrode 400 has a safety clamp 50 disposed above the top end of the casing 1, which grips the surface of the core 2″.

FIG. 12 shows the charging device 34 with a mounting device 51 that supports an electrographite electrode element.

In FIGS. 9A and 12A a variant of the second embodiment of the electrode 400 is illustrated, in which the extrusion device 10 is eliminated. In this variant a sliding clamp 55 which grips the surface of the core 2 is added beneath the safety clamp 50. An extrusion cylinder 56 substantially similar to the extrusion device 10 is interposed between the safety clamp 50 and the sliding clamp 55.

The safety clamp 50 is supported by a floating suspension 57 constrained to the rigid mechanical connection 22. A load cell 58 to measure the load supported by the suspension 57 is provided on the floating suspension 57.

The possible operating modes of the electrode according to the invention will now be described.

Complete Sliding of the Electrode

In the eventuality of deterioration of the part of the casing 1 contained between the contact plates 5, due to flame or other factors, complete sliding of the electrode is carried out. This operation is performed with the furnace in operation and consists in causing a pre-established linear amount of the electrode and of the relative casing to emerge beneath the bottom tip of the plates.

This operation is effected by performing the following steps:

The upper clamp 15 is released,

The jack 17 is operated to raise the upper clamp 15, free from the casing 1, by an established distance,

The upper clamp 15 is locked,

The lower clamp 16 is released,

The jack 17 is operated to cause lowering of the upper clamp 15 which pulls the casing 1 downward

At this point the following step is carried out:

The extrusion cylinder 11 is operated so that the piston 13 makes a stroke equal to that of the jack 17.

The complete sliding operation can be repeated without performing the entire cycle again. In fact it is sufficient to act simultaneously on the extrusion device 10 and the additional jacks 18.

Sliding of Only the Inner Part of the Electrode (Extruded)

The extruded sliding operation is performed completely automatically with the furnace in operation. The rate of sliding is determined by the linear consumption of the baked electrode 8.

This operation consists in setting the stroke of the piston 13 within the extrusion cylinder 11 to a pre-established amount such as to obtain an extension of the piston 13 equal to the linear amount of sliding desired.

Should the weight F of the inner part of the electrode not be sufficient to overcome the friction between the casing 1 and the inner part of the electrode, this operation is completed by intervening on the contact plates 5, modifying the pressure on the electrode.

Assembly of New Elements of the Inner Anchoring Structure

The operation of replenishment of the core 2 becomes necessary when, following continuous sliding of the inner part of the electrode, the piston 13 of the extrusion cylinder 11 is situated in the vicinity of the lower end of stroke limit. This manoeuvre is performed with the furnace in operation and consists in locking the core 2 with respect to the casing 1.

In the first embodiment the core 2′ is locked by insertion of the safety cross piece 40.

In the second embodiment the core 2″ is blocked by operating the safety clamp 50.

Assembly of New Casing Elements

This operation is necessary when subsequent complete sliding operations have brought the upper edge of the last casing element near to the upper edge of the upper clamp 15. Replenishment takes place, with the furnace working, by inserting a suitably prepared new casing element on the top end of the casing 1.

Regulation of Self-baking of the Electrode Paste

Baking of the electrode paste depends not only on the physical characteristics of its components, but also on a considerable series of outside factors, including the structural type of furnace, the operating conditions in the furnace, and the environmental situation.

For good operation of the extruded electrode according to the invention it is of fundamental importance for the level of baking to be maintained within the ideal band of the electrode, called the retaining disc, in which the intimate union between the core 2 and the electrode paste in the final phase of solidification takes place. To fulfil this condition also as the sliding speed of the electrode varies, according to the invention the level of self baking of the electrolytic paste is regulated essentially by acting on three points.

The voltage signal between the core 2 and the casing 1 is measured constantly by means of the baking meter.

The pressure value within the extrusion cylinder 11 is constantly measured by means of the pressure detector PT.

The thermal distribution inside the electrode column is measured at regular intervals by means of thermal detectors (not shown).

The data obtained from these measurements are suitably interpolated to provide the exact self-baking profile of the paste. To maintain this ideal self-baking profile constant, three regulations combined and coordinated with each other are used.

The barrier air in the gap between the casing and the inner part of the electrode is thermoregulated by means of the air supply 24.

The pressure of the plates 5 on the casing 1 is regulated by means of the plate-pushing jacks 6.

The water in the cooling circuit of the contact plates 5 is thermoregulated. By means of this thermoregulation the water can raise the temperature of the copper of the contact plates to a level very near to the final cracking temperature, without running any risk of deterioration of the plates themselves. These contact plates 5 do not have to be replaced and do not have to undergo any mechanical modification according to the type of electrode in use.

This method of regulating self-baking, obtained by means of the measurements and thermoregulations described previously, is particularly indicated for furnaces with airtight columns where the contribution of heat through radiation is completely lacking.

Regulation of the Maximum Torsion and Shearing Force of the Inner Anchoring Structure

Said regulation takes place by means of measurement of two reference signals:

The furnace rotation torque signal;

The listing and oscillating signal of the core 2 with respect to the casing 1.

The torque signal is compared with a pre-set threshold signal. If the torque signal exceeds said threshold signal rotation of the furnace is slowed or in extreme cases stopped.

The listing signal, on the other hand, has an indicative function. In fact the danger of dragging of the core 2 has been eliminated by adopting a suitable suspension system 30 which allows the core 2 to oscillate and dampen all the sudden changes which inevitably occur during charging of the furnace.

Passage from Pre-baked Electrode to Söderberg Electrode or to Extruded Electrode

With reference to FIGS. 13-15 the elements and accessories for passing, without breaks in the production cycle, from the pre-baked amorphous carbon electrode to the conventional Söderberg electrode (FIG. 13), to the extruded electrode with metal core (FIG. 14), and to the extruded electrode with electrographite core (FIG. 15) are shown schematically in cross section.

FIG. 13 shows a pre-baked electrode element 500 placed at the top. On the top end of the element 500 an axial hole is provided in which an electrographite nipple 501 with a metal core 502 engages. The electrographite nipple 501 is retained by a top disc 503 and a bottom disc 504.

Above the top disc 503, around the metal core 502, fins 505 are provided which engage in the inner wall of a first element of the casing 101 of a Söderberg electrode, with the relative anchoring structure 102 integral therewith. The bottom end of the casing 101 is fixed to the top end of the element 500 by means of nailing 506 to a lower limit indicated by the dashed line 507.

The solid electrode paste 103 is introduced into the casing 101. In this manner, when the last element 500 of the pre-baked electrode is consumed, the passage to the Söderberg electrode is automatic.

As shown in FIG. 14, the fins 505 of the nipple 501 are fixed to the metal core 2′ of an extruded electrode. Instead of using the casing 101 of the Söderberg electrode, use is made of a typical cylindrical extruded electrode casing which is fixed by nailing 506 to the pre-baked electrode element 500.

As shown in FIG. 15, instead of the nipple 501, a threaded graphite element 510 which is the terminal part of the electrographite core 2″ of the extruded electrode is used. The casing 1 is fixed to the pre-baked electrode element 500 as in the previous cases.

Passage from Söderberg Electrode to Extruded Electrode

FIG. 16 shows the passage from a Söderberg electrode 100 to an extruded electrode 300 with a metal core 2′. The bottom end of the metal core 2′ has fins 520 which engage with the tongues 102 of the casing 101 of the Söderberg electrode. Furthermore a join 521 is made between the casing 101 of the Söderberg electrode and the casing 1 of the extruded electrode 300.

FIG. 17 shows the passage from a Söderberg electrode 100 to an extruded electrode 400 with electrographite core 2″. In this case the end part 510 of the core 2″ is threaded and engages in an axial hole provided in the paste 103 of the Söderberg electrode 16. In this case also a join 521 is made between the casing 1 of the extruded electrode and the casing 101 of the Söderberg electrode.

Passage from Extruded Electrode with Metal Core to Extruded Electrode with Electrographite Core and Vice Versa

FIG. 18 shows the passage from an extruded electrode 300 with a metal core 2′ to an extruded electrode 400 with an electrographite core 2″. Fixed to the top end of the metal core 2′ of the electrode 300 are metal fins 536 integral with the tubular metal core 531 inside an electrographite element 530 disposed at the bottom end of the graphite electrode 2″.

The tubular metal core 531 carries at its ends a bottom disc 533 and a top disc 532 which retain the graphite element 530. The graphite element 530 is made integral with the graphite core 2″ by means of a sleeve 534 which is fixed by nailing 535 to the surface of the graphite element 530 and of the graphite electrode 2″.

FIG. 19 shows the passage from an extruded electrode 400 with an electrographite core 2″ to an extruded electrode 300 with a metal core 2′. As can be seen, FIG. 19 is substantially the same as FIG. 18 upside-down. In this case the top end of the graphite electrode 2″ is fixed to the graphite element 530 which has the core 531 with metal fins 536 that engage with the bottom end of the metal core 2′ of the electrode 300.

1. Extruded self-baking electrode for submerged arc electric furnace comprising:
a metal outer casing (1), substantially cylindrical in shape, on which electrical contact plates (5) are applied for electrical supply;
an inner part comprising electrode paste (3, 7, 8) anchored to an anchoring core (2) axially arranged into said casing (1),
an extrusion device (10) connected to said anchoring core (2) to control axial sliding of said inner part of the electrode with respect to said casing (1), characterized in that the downward axial sliding of the inner part of the electrode with respect to the casing (1) takes place through the action of the force of gravity, through the help of regulation and control means for baking of the electrode paste (8), while said casing (1) is kept fixed by means of clamping means (14, 15).

2. An electrode according to claim 1 characterized in that said control means for baking of the electrode paste (8) comprise:
a voltage detector (VT) to measure the voltage difference between the core (2) and the casing (1),
a pressure detector (PT) to measure the pressure of the extrusion device (10),
at least one thermal detector to detect the heat distribution of the inner part of the electrode.

3. An electrode according to claim 1 or 2, characterized in that said regulation means for baking of the electrode paste (8) comprise:
a an air inlet (24) to blow air into the gap between the casing (1) and the inner part of the electrode,
plate-pusher jacks (6) to regulate the pressure of the electrical contact plates (5) on the casing (1).

4. An electrode according to any one of the preceding claims, characterized in that said anchoring core (2) comprises a metal structure which is substantially cross-shaped in cross-section.

5. An electrode according to any one of claims 1 to 3, characterized in that said anchoring core (2) comprises an electrographite structure having a substantially cylindrical shape.

6. An electrode according to any one of the preceding claims, characterized in that said extrusion device (10) comprises a cylinder (11) defining an inner chamber (12) wherein a piston (13) which supports said anchoring core (2) slides.

7. An electrode according to claim 6 characterized in that said chamber (12) of the extrusion cylinder (11) is filled with oil and said pressure detector (PT) measures oil pressure in said chamber (12).

8. An electrode according to any one of the preceding claims, characterized in that said extrusion device (10) is mounted in an oscillating manner by means of an oscillating device (30) to allow oscillation of the inner part of the electrode.

9. An electrode according to any one of the preceding claims, characterized in that said clamping means are a pair of clamps (15, 16) applied to the outer surface of the casing (1).

10. An electrode according to any one of the preceding claims, characterized in that sliding means (17) are provided to allow axial sliding of the casing (1).

11. An electrode according to claim 10, characterized in that said sliding means are jacks (17) interposed between an upper clamp (15) and a lower clamp (16) of said pair of clamps.

12. An electrode according to any one of the preceding claims, characterized in that safety locking means (40, 50) are provided for safety locking of said core (2).

13. An electrode according to claim 10, characterized in that said safety locking means (40) are a safety crosspiece disposed at the top end of said casing (1)

14. An electrode according to claim 10, characterized in that said safety locking means (50) are at least one safety clamp (50) applied to the outer surface of said core (2), above the top end of said casing (1).
